(19) United States
(12) Patent Application Publication
(10) Pub. No.: US 2026/0064546 A1
(43) Pub. Date: Mar. 5, 2026

(54) SYSTEMS AND METHODS FOR SCALABLE BLOCK-BASED PERMANENT SAFETY FAULT TOLERANCE

(71) Applicant: QUALCOMM Incorporated, San Diego, CA (US)

(72) Inventors: Amit DUGGAL, Bangalore (IN); Sateeshkumar INJARAPU, Bangalore (IN); Nitin JAISWAL, Bangalore (IN)

(21) Appl. No.: 18/826,031

(22) Filed: Sep. 5, 2024

(51) Int. Cl. G06F 11/14; G06F 9/48

(52) U.S. Cl. CPC G06F 11/1497; G06F 9/4881; G06F 2201/805

(57) ABSTRACT

A method includes detecting a functional safety fault and determining whether the functional safety fault is a transient fault or a permanent fault. The method further includes identifying a scalable block of a processing unit from which the functional safety fault occurred in response to the functional safety fault being determined to be a permanent fault. The method optionally includes power collapsing the scalable block. The method also includes notifying a scheduler to prevent the scheduler from scheduling future workloads to the scalable block.

### FIELD OF THE DISCLOSURE

Aspects of the present disclosure generally relate to hardware recovery, and more particularly to systems and methods for scalable block-based permanent safety fault tolerance.

### BACKGROUND

Functional safety is an aspect of computer systems design, particularly in automotive, aerospace, industrial automation, and medical device contexts. Functional safety includes implementing safety mechanisms to increase the likelihood that a system behaves predictably and safely in the presence of faults. Functional safety standards provide frameworks for the development, validation, and verification of safety systems. These standards include rigorous risk assessment, hazard analysis, and the use of redundant and diverse design techniques to mitigate potential hazards. Conventional strategies for implementing functional safety involve safety integrity levels (SILs), fail-safe and fail-operational modes, and comprehensive safety case documentation to demonstrate that safety specifications are satisfied throughout the product lifecycle.

Functional safety techniques may include detecting permanent and transient faults in computer systems to maintain reliability and safety. Permanent faults, often caused by hardware defects or aging, may be identified through built-in self-test (BIST) mechanisms, periodic diagnostic checks, and redundancy techniques such as triple modular redundancy or dual modular redundancy. Transient faults, often induced by environmental factors such as cosmic rays or electromagnetic interference, specify different strategies. These strategies include error detection and correction devices, watchdog timers, and dynamic reconfiguration methods. Advanced fault detection techniques employ real-time monitoring and machine learning techniques to predict and mitigate faults before they affect system operation. By combining these techniques, systems can achieve high levels of fault tolerance and provide continuous, safe operation even in the presence of diverse fault conditions.

### SUMMARY

According to aspects of the present disclosure, a method includes detecting a functional safety fault. The method also includes determining whether the functional safety fault is a transient fault or a permanent fault. The method further includes identifying a scalable block of a processing unit from which the functional safety fault occurred in response to the functional safety fault being determined to be the permanent fault. The method still further includes power collapsing the scalable block and notifying a scheduler to prevent the scheduler from scheduling future workloads to the scalable block.

Other aspects of the present disclosure are directed to an apparatus. The apparatus has at least one memory and one or more processors coupled to the at least one memory. The processor(s) is configured to detect a functional safety fault. The processor(s) is also configured to determine whether the functional safety fault is a transient fault or a permanent fault. The processor(s) is further configured to identify a scalable block of a processing unit from which the functional safety fault occurred in response to the functional safety fault being determined to be the permanent fault. The processor(s) is still further configured to notify a scheduler to prevent the scheduler from scheduling future workloads to the scalable block.

In still other aspects of the present disclosure, a non-transitory computer-readable medium with program code recorded thereon is disclosed. The program code is executed by at least one processor and includes program code to detect a functional safety fault. The program code also includes program code to determine whether the functional safety fault is a transient fault or a permanent fault. The program code further includes program code to identify a scalable block of a processing unit from which the functional safety fault occurred in response to the functional safety fault being determined to be the permanent fault. The program code still further includes program code to power collapse the scalable block and notify a scheduler to prevent the scheduler from scheduling future workloads to the scalable block.

Other aspects of the present disclosure are directed to an apparatus. The apparatus includes means for detecting a functional safety fault. The apparatus also includes means for determining whether the functional safety fault is a transient fault or a permanent fault. The apparatus further includes means for identifying a scalable block of a processing unit from which the functional safety fault occurred in response to the functional safety fault being determined to be the permanent fault. The apparatus still further includes means for notifying a scheduler to prevent the scheduler from scheduling future workloads to the scalable block.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example implementation of a system-on-a-chip (SOC), in accordance with various aspects of the present disclosure.

FIG. 2 illustrates an example of an automobile including systems that may be adapted, configured, or operated, in accordance with various aspects of the present disclosure.

FIG. 3 is a block diagram illustrating an example of a system that may be incorporated in a vehicle subsystem.

FIG. 4 is a block diagram illustrating a system that includes a processing circuit.

FIG. 5 is a block diagram illustrating a configuration of subsystems and circuits that may be used to perform self-testing during initialization of the processing circuit illustrated in FIG. 4.

FIG. 6 is a block diagram illustrating a configuration of subsystems and circuits that may be used to perform self-testing and identification of transient fault conditions.

FIG. 7 is a flow chart that illustrates certain aspects of a dynamic self-testing technique that can be implemented using the subsystems and circuits illustrated in FIG. 6.

FIGS. 8A and 8B are block diagrams illustrating a scalable block-based processor configured for fault management, in accordance with various aspects of the present disclosure.

FIG. 9 is a flow chart illustrating a process to address hardware faults in a scalable block-based processor, in accordance with various aspects of the present disclosure.

FIG. 10 is a flow chart illustrating an example process performed, for example, by a scalable block-based processor, in accordance with various aspects of the present disclosure.

FIG. 11 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Several aspects of slice-based fault tolerance will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

As discussed, aspects of the present disclosure relate to fault categorization and handling in automotives. Due to the strict safety standards specified in automotive design, identifying and categorizing system faults and taking corrective action is often performed by various automotive subsystems. These subsystems work to prevent detected faults from compromising vehicle safety. Various techniques are directed to categorizing system faults and taking corrective action. For example, during compute processing, if a system reports a functional safety fault in a scalable block or slice of a processor, the system may first determine if the fault is transient or permanent. If the fault is transient, the system may implement software solutions to fix the fault within seconds. For example, a workload may be re-executed on the scalable block after a predetermined time has elapsed, for example 10 milliseconds. In other words, a context may be re-executed such that the same code executes again from a previous saved check point in the software. However, if the fault is permanent, the system may specify technician intervention to provide a hardware or software fix or may re-boot the system.

Because permanent faults specify extensive hardware or software fixes, permanent faults often lead to long periods of time in which the automotive subsystem is inoperable. For instance, a driver may not be able to use the automotive subsystem until the driver can have the automobile towed to a technician for repairs. Worse yet, permanent faults may disable an automobile while a driver is traveling, thus leaving the driver stranded in the middle of their journey. Various conventional techniques exist to address permanent safety faults, but these techniques are undesirable for various reasons. One technique includes implementing redundant hardware to act as a backup for automotives systems. However, this redundant hardware specifies additional space and fabrication costs without providing increased performance to the automobile. Therefore, a solution is needed to provide permanent fault tolerance more efficiently in functional safety applications.

Various aspects of the present disclosure are directed to functional safety techniques for improving fault tolerance of slice-based processors. In some implementations, a graphics processing unit (GPU) detects a functional safety fault. The GPU may then implement a built-in self-test (BIST) technique to determine whether the fault is a transient fault or a permanent fault. If the fault is determined to be a transient fault, the GPU re-performs the workload impacted by the fault. If the fault is determined to be a permanent fault, however, the GPU determines which slice hosts the fault. A power controller then power collapses the faulty slice. Further, a notification is transmitted to a scheduler to prevent the scheduler from scheduling workloads on the power collapsed slice.

As noted, various aspects of the present disclosure implement slice-based architecture. Slice-based architecture implements slices, replicated processing elements within a processor that allow for dynamic adjustment of processing. Slices can be power collapsed while routing workloads to a different slice, resulting in a reduction in performance but not in functionality. In conventional architectures, processors such as GPUs and central processing units (CPUs) perform specific roles, such as image processing and general-purpose processing, respectively. Processors are configured based on their roles, and disabling a processor leads to a reduction in system functionality.

In contrast to conventional architectures, slice-based architecture offers dynamic processing adjustment techniques. Each slice, comprising various computational and/or memory units, may be power collapsed while routing workloads to a different slice. Power collapsing a slice results in a reduction in performance but not in functionality. For instance, in video processing, power collapsing a slice may reduce system output resolution or the number of frames processed per second, but the processor comprising the slice remains functional. In some implementations, a slice-level power controller manages power routed to each slice and can power collapse a slice based on indications received from a fault categorization component. Thus, slice-based architecture provides a more flexible approach to workload distribution to reduce processing redundancy.

A slice may also be referred to as a scalable block throughout this application. A slice or scalable block is a set of sub modules in a processing core with a predefined function, which can be repeated multiple times in hardware to achieve higher performance without impacting the overall functionality of the core. A slice or scalable block is a subset of a core and not a multi-core design.

Particular aspects of the subject matter described in this disclosure can be implemented to realize one or more of the following potential advantages. In some examples, the described techniques, such as power collapsing a slice affected by a permanent fault, enables processing units to remain operational despite experiencing a permanent fault. Other advantages include determining whether the fault is permanent or transient before power-collapsing a slice, which helps to prevent a permanent loss of performance due to a temporary fault. Additionally, aspects of the present disclosure may be implemented in automotive subsystems, thus increasing safety in automotive applications without using expensive redundant processing architecture.

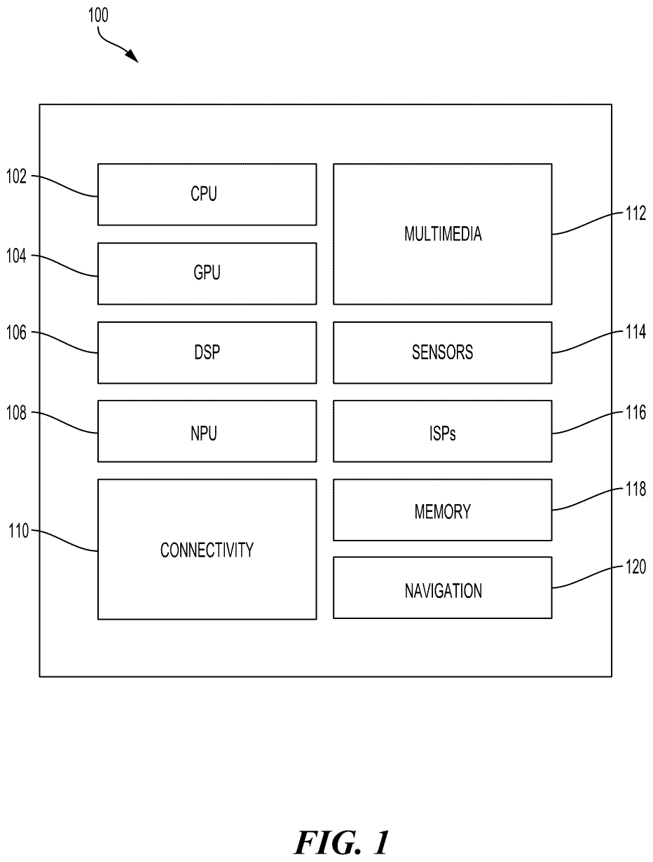

FIG. 1 illustrates an example implementation of a system-on-a-chip (SOC) 100, which may include a central processing unit (CPU) 102 or a multi-core CPU configured for slice-based processing. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the CPU 102 may include code to detect a functional safety fault. The instructions loaded into the CPU 102 may additionally include code to determine whether the functional safety fault is a transient fault or a permanent fault. The instructions loaded into the CPU 102 may further include code to identify a scalable block of a processing unit from which the functional safety fault occurred in response to the functional safety fault being determined to be the permanent fault. The instructions loaded into the CPU 102 may also include code to power collapse the scalable block and notify a scheduler to prevent the scheduler from scheduling future workloads to the scalable block.

According to aspects of the present disclosure, an apparatus includes multiple scalable blocks and a scalable block-level power controller. The apparatus may include means for detecting, means for determining, means for identifying, means for power collapsing, means for notifying, means for re-executing, means for storing, means for inverting, means for writing, means for comparing, means for resetting, and means for toggling.

For example, the means for detecting may be any of the CPU 102, GPU 104, DSP 106, NPU 108, ISP 116, or ECC fault logger 810. For example, the means for determining may be any of the CPU 102, GPU 104, DSP 106, NPU 108, ISP 116, ECC fault logger 810, or fault categorization component 812. For example, the means for identifying may be any of the CPU 102, GPU 104, DSP 106, NPU 108, ISP 116, ECC fault logger 810, or fault categorization component 812. For example, the means for power collapsing may be any of the CPU 102, GPU 104, DSP 106, NPU 108, ISP 116, slice-level power controller 814, or power gate 820. For example, the means for notifying may be any of the CPU 102, GPU 104, DSP 106, NPU 108, ISP 116, functional workload scheduler 802, or slice-level power controller 814.

For example, the means for re-executing may be any of the CPU 102, GPU 104, DSP 106, NPU 108, ISP 116, or functional workload scheduler 802. For example, the means for storing may be any of the CPU 102, GPU 104, DSP 106, NPU 108, ISP 116, ECC fault logger 810, or fault categorization component 812. For example, the means for inverting may be any of the CPU 102, GPU 104, DSP 106, NPU 108, ISP 116, or fault categorization component 812. For example, the means for writing may be any of the CPU 102, GPU 104, DSP 106, NPU 108, ISP 116, or fault categorization component 812. For example, the means for comparing may be any of the CPU 102, GPU 104, DSP 106, NPU 108, ISP 116, or fault categorization component 812. For example, the means for resetting may be any of the CPU 102, GPU 104, DSP 106, NPU 108, ISP 116, or fault categorization component 812. For example, the means for toggling may be any of the CPU 102, GPU 104, DSP 106, NPU 108, ISP 116, slice-level power controller 814, or power gate 820.

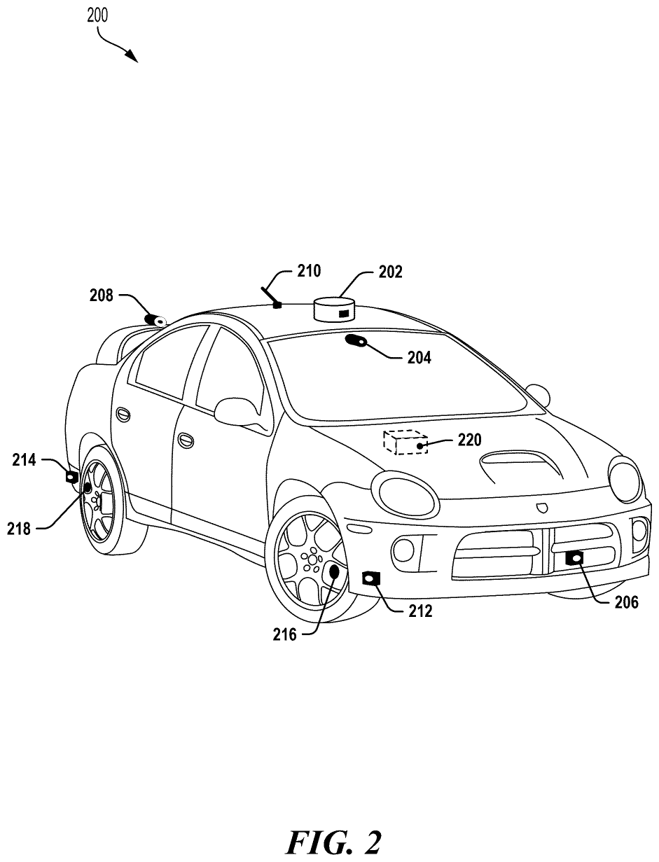

FIG. 2 illustrates an example of an automobile 200 including systems that may be adapted, configured, or operated, in accordance with various aspects of the present disclosure. The automobile 200 may be equipped with multiple imaging or sensing devices including, for example, cameras 202, 204, 206, 208, 212, 214, and sensors 216, 218. The automobile 200 may include sensors such as tire pressure or braking sensors as the sensors 216, 218. The automobile 200 may also include one or more antennas 210 for radio frequency reception, wireless communication, and/or radio navigation using a position location system, such as a global positioning system (GPS). A central controller 220 may be coupled to each of the cameras 202, 204, 206, 208, 212, 214, sensors 216, 218, and antennas 210. The central controller 220 may configure and manage automated systems and/or driver assistance systems. In some implementations, the central controller 220 may be configured to operate as an engine control unit that manages the operation and performance of the engine, motor, motors, or other power systems in the automobile 200. In some instances, the central controller 220 may include an SOC, such as the SOC 100 illustrated in FIG. 1.

Robust data communication links are specified to support the large number of cameras (e.g., 202, 204, 206, 208, 212, 214) deployed within the automobile 200. In some examples, 20-30 cameras may be deployed to support automation and driver assistance systems. Each camera may be capable of generating data at a rate of between 1-10 gigabits per second (Gbps) resulting in aggregate data rates of up to 300 Gbps. The communication of this volume of data can be expected to result in the consumption of high levels of power and the generation of associated heat from interface and data protection and processing circuits. In conventional systems, data rates may be reduced to control power consumption and heat generation, resulting in loss of image quality.

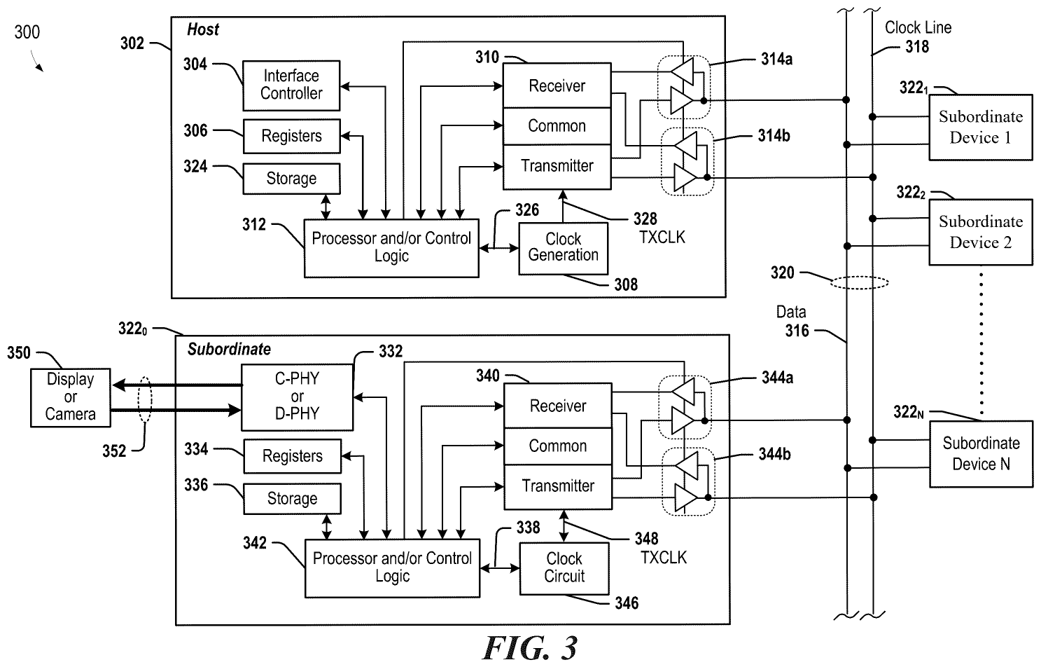

FIG. 3 is a block diagram illustrating an example of a system 300 that may be incorporated in a vehicle subsystem, such as a subsystem of the automobile 200 of FIG. 2. As illustrated in FIG. 3, the system 300 includes devices 302 and 322₀-322_{N} coupled to a serial bus 320, the serial bus 320 being two-wire. The devices 302 and 322₀-322_{N} may be implemented using an SOC and/or one or more semiconductor integrated circuit (IC) devices. In various implementations, the devices 302 and 322₀-322_{N} may support or operate as a modem, a signal processing device, a display driver, a camera, a user interface, a sensor, a sensor controller, a media player, a transceiver, and/or other such component or device. In some examples, one or more devices 322₀-322_{N} may control, manage, or monitor a sensor device. Communication between devices 302 and 322₀-322_{N} over the serial bus 320 is controlled by a host device 302 that serves as a bus master. Certain types of buses can support multiple bus masters.

In one example, the host device 302 may include an interface controller 304 that can manage access to the serial bus, configure dynamic addresses for subordinate devices, and/or generate a clock signal 328 (shown as TXCLK) to be transmitted on a clock line 318 of the serial bus 320. The host device 302 may include configuration registers 306 or other storage 324, and control logic 312 configured to handle protocols and/or higher-level functions. The control logic 312 may include a processing circuit such as a state machine, sequencer, signal processor, or general-purpose processor. The host device 302 includes a transceiver 310 and line drivers/receivers 314a and 314b. The transceiver 310 may include a receiver, a transmitter, and common circuits, where the common circuits may include timing, logic, and storage circuits and/or devices. In one example, the transmitter encodes and transmits data based on timing in the clock signal 328 provided by a clock generation circuit 308. Other timing clocks 326 may be used by the control logic 312 and other functions, circuits, or modules.

At least one device 322₀-322_{N} may be configured to operate as a subordinate device on the serial bus 320 and may include circuits and modules that support a display, an image sensor, and/or circuits and modules that control and communicate with one or more sensors that measure environmental conditions. In one example, a device 322₀ configured to operate as a subordinate device may provide a control function, physical layer circuit 332 that includes circuits and modules to support a display, an image sensor, and/or circuits and modules that control and communicate with one or more sensors that measure environmental conditions. In this example, the device 322₀ can include configuration registers 334 or other storage 336, control logic 342, a transceiver 340, and line drivers/receivers 344a and 344b. The control logic 342 may include a processing circuit such as a state machine, sequencer, signal processor, or general-purpose processor. The transceiver 340 may include a receiver, a transmitter, and common circuits, where the common circuits may include timing, logic, and storage circuits and/or devices. In one example, the transmitter encodes and transmits data based on timing in a clock signal 348 provided by clock generation and/or recovery circuits 346. In some instances, the clock signal 348 may be derived from a signal received from the clock line 318. Other timing clocks 338 may be used by the control logic 342 and other functions, circuits, or modules.

The serial bus 320 may be operated in accordance with controller area network (CAN) bus protocols promulgated by the International Organization for Standardization (ISO), ETHERNET, inter-integrated circuit (I2C or I²C) protocols, improved inter-integrated circuit (I3C) protocols, radio frequency front-end (RFFE) protocols, system power management interface (SPMI) protocols, serial peripheral interface (SPI) protocols, or other suitable protocols. In some instances, two or more devices 302, 322₀-322_{N} may be configured to operate as a host device on the serial bus 320. In some instances, the system 300 includes multiple serial buses 320, 352a, and/or 352b that couple two or more of the devices 302, 322₀-322_{N} or one of the devices 302, 322₀-322_{N} and a peripheral device such as a display or camera 350. In some examples, one subordinate device 322₀ is configured to operate as a display or camera coupled to a display or camera 350. The latter subordinate device 322₀ may include a physical layer circuit 332 that is configured to enable communication with the display or camera 350 over a bus 352.

One or more of the devices 302, 322₀-322_{N} may be implemented in an SOC that provides a standardized or proprietary bus architecture for interconnecting the devices. In one example, an SOC may be implemented using multiple chiplets mounted on a common chip carrier and coupled through data communication buses operated according to universal chiplet interconnect express (UCIe). In another example, an SOC may include one or more data communication buses that are operated in accordance with advanced high-performance bus (AHB) protocols defined by advanced microcontroller bus architecture (AMBA) specifications. Other bus architectures or protocols may be employed to satisfy design or application specifications. Examples of other types of bus architectures or protocols are defined by CAN, Ethernet, RFFE, I2C, I3C, SPMI, peripheral component interconnect express (PCIe), advanced extensible interface (AXI), HyperTransport, and InfiniBand standards or protocols. Certain bus architectures may be deployed to support inter-processor communications, inter-device communications, sensor support, high-speed communication, and/or memory interfaces.

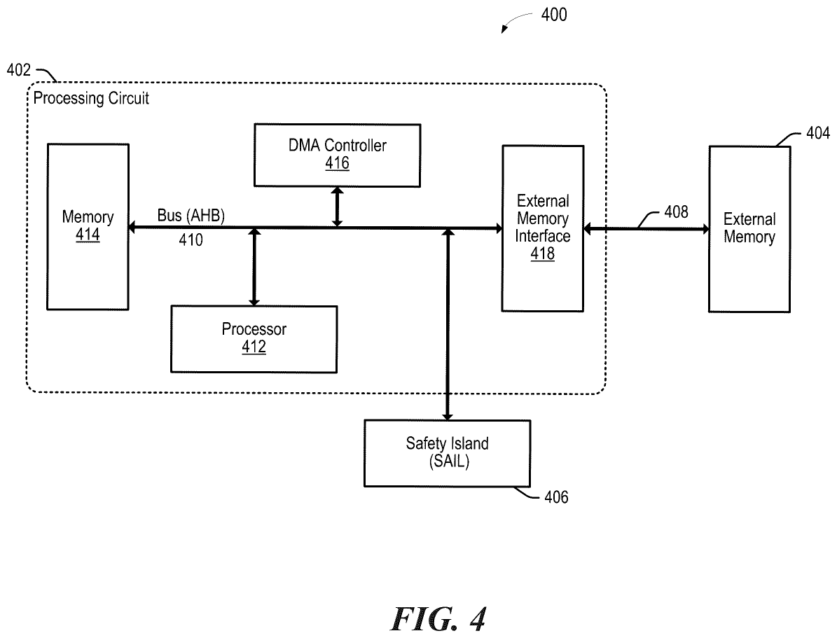

FIG. 4 is a block diagram illustrating a system 400 that includes a processing circuit 402. In one example, the processing circuit 402 may be included in the host device 302 illustrated in FIG. 3. In another example, the processing circuit 402 may be included in a subordinate device, and may be associated with one or more of the other devices 322₀-322_{N} illustrated in FIG. 3.

The processing circuit 402 may be implemented within an SOC and includes a processor 412 that is coupled through a system bus 410 to internal memory 414 and external memory 404. The internal memory 414 and external memory 404 can be used to store code, data, configuration, and status information. The system bus 410 may be operated in accordance with AHB protocols. A direct memory access (DMA) controller 416 may couple to the system bus 410 to permit other processors, peripherals, or devices to access the internal memory 414 and/or external memory 404. An external memory interface 418 or memory controller may couple to the system bus 410. The external memory interface 418 may further couple to the external memory 404 through a separate or external memory bus 408.

Other peripherals may couple to the system bus 410. For example, one or communication interfaces may couple to the system bus 410 in order that the processor 412 may communicate or control one or more sensors, displays, cameras, wireless communication modems, and/or other processing circuits.

As shown in FIG. 4, a safety island 406 couples to the system bus 410. The safety island 406 is a safety subsystem or circuit that may be implemented within the same SOC that includes the processing circuit 402. In some implementations, the safety island 406 is provided external to the SOC that includes the processing circuit 402. The safety island 406 may be configured to manage built-in self-test (BIST) subsystems and to monitor subcircuits of the SOC during operation. In some implementations, the safety island 406 may be configured to manage a BIST controller that monitors a memory component, and which may be referred to as a memory built-in self-test (MBIST) controller. The safety island 406 includes circuits that can identify or be alerted to fault conditions or failures during normal operation. The safety island 406 may be configured to force restart of some or all components of the system 400 as specified to recover from fault conditions or failures. The safety island 406 may be configured to signal system failure through external display or notification systems.

The safety island 406 may be expected to continue to function when faults and failures have occurred within the system 400. Accordingly, the safety island 406 may be isolated from the operation of other subsystems and circuits. In some implementations, the safety island 406 includes a dedicated processing circuit, dedicated memory, and independent clock generation or delivery circuits. In some implementations, the safety island 406 may be allocated dedicated input/output (I/O) pins and associated circuits. In some implementations, the safety island 406 may be provided with independent access to communication interfaces. The safety island 406 may be powered independently of the processing circuit 402.

The four automotive safety integrity levels (ASILs) in the ISO 26262 risk classification standard are associated with levels of performance, accuracy, and reliability stipulated for systems and data to provide acceptable levels of functional safety in different autonomous driving modes. In one example, ASIL-D defines levels of performance, accuracy, and reliability associated with the highest degree of automotive risk, for systems including airbags, anti-lock brakes, and power steering. In another example, ASIL-A defines levels of performance, accuracy, and reliability associated with the lowest degree of automotive risk, for systems such as rear lights. In another example, ASIL-B defines levels of performance, accuracy, and reliability for systems such as head lights, brake lights and the like. In another example, ASIL-C defines levels of performance, accuracy, and reliability for systems such as cruise control.

Levels of performance, accuracy, and reliability in memory devices may be defined by ASIL-B. ASIL-B specifies that data stored in memory devices are protected using an error correction code (ECC). The ECC may be generated as a Hamming code, a Hsiao code, a Reed-Solomon error correction code, or the like. The ECC may provide for single-bit error correction and double-bit error detection (SEC-DED). Memory devices that use an ECC can protect against data corruption caused by electromagnetic interference events and other events that can cause the value of a single bit to flip. ECC circuits in a memory device can also detect that localized failure in the value stored at a location of the memory device is corrupted due to the value of one or more bits of the storage location being permanently fixed or locked. ECC circuits in a memory device may be configured to report memory faults, such as bit errors, to the safety island 406.

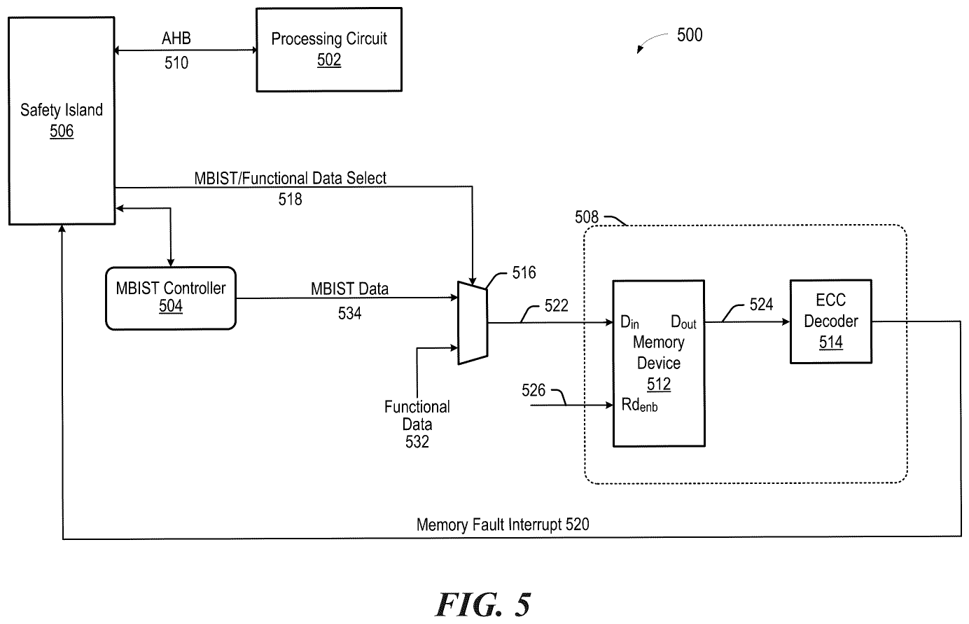

FIG. 5 is a block diagram illustrating a configuration of subsystems and circuits 500 that may perform self-testing during initialization of the processing circuit 402 illustrated in FIG. 4. The illustrated self-testing is directed to a memory component 508. The memory component 508 of FIG. 5 corresponds to the external memory 404 coupled to the processing circuit 402 of FIG. 4. In other examples, the memory component 508 of FIG. 5 corresponds to the internal memory 414 of the processing circuit 402 of FIG. 4. The memory component 508 includes one or more memory devices 512 providing an addressable memory space spanning an address range, and an ECC decoder 514, configured to identify data corruption. The ECC decoder 514 may assert a memory fault interrupt 520 that causes one or more circuits or modules in a safety island 506 to initiate corrective action, and/or to notify an operator or other elements of an autonomous or driver operated vehicle of the potential consequences of the data corruption. The safety island 506 may couple to a processing circuit 502 through a bus 510 that operates in accordance with AHB protocols, and may receive one or more signals from the memory component 508.

The safety island 506 may be configured to manage or monitor the operation of an MBIST controller 504 that may test certain aspects of the performance, accuracy, and reliability of the memory component 508. In one example, the MBIST controller 504 may be implemented using a finite state machine. In another example, the MBIST controller 504 may be implemented using the processing circuit 502. The MBIST controller 504 operates during system initialization or after a fault condition has been detected and the system, processing circuit 502, or memory component 508 is being reset or reinitialized. In one example, a circuit in the safety island 506 may provide a control signal 518 to a multiplexer 516 that selects between a test data stream 534 and functional data 532. The test data stream 534 may also be referred to as MBIST data. Functional data 532 is received during normal operation of the system. The system may be operating normally when it is performing one or more functions for which it was designed or configured. The safety island 506 may cause the MBIST controller 504 to generate other memory control signals (not shown) in order to enable data to be written to the memory component 508 and to be read from the memory component 508 during testing. For example, the MBIST controller 504 may override a read enable signal 526 provided to the memory devices 512 for normal operation with a test version of the read enable signal during testing.

During testing, the multiplexer 516 selects the test data stream 534 to be provided as data input 522 of the memory devices 512. The test data stream 534 may be written to multiple locations across the address range of the memory component 508. In one example, test data is written to every address in the address range. In another example, test data is written to random addresses throughout the address range. The MBIST controller 504 may test the memory devices 512 to ensure the integrity of the stored data. In some implementations, the MBIST controller 504 may obtain a regenerated test data stream 524 by reading the data that was stored at the multiple locations during writing. The ECC decoder 514 may check the ECC information associated with the regenerated test data stream 524 to determine whether the regenerated test data stream 524 includes errors. The regenerated test data stream 524 is expected to match the test data stream 534. If a difference is detected or discovered, the ECC decoder 514 may assert the memory fault interrupt 520.

The safety island 506 may initiate one or more additional memory tests when the memory fault interrupt 520 is asserted. Additional memory tests may determine if a reported fault is permanent or transient. The safety island 506 may cause certain memory locations to be excluded from available memory when the reported fault is permanent. Circuits or modules within the safety island 506 may determine the criticality of the fault and may take further action based on such determination.

The circuits or modules within a conventional safety island 506 are unable to distinguish between permanent and transient faults during normal operations. The safety island 506 responds to a fault indication by causing the affected subsystem to reset and be tested during reinitialization. In the example illustrated in FIG. 5, circuits or modules within the safety island 506 respond to assertion of the memory fault interrupt 520 by causing the memory component 508 to reset. In some instances, the circuits or modules responsive to memory faults within the safety island 506 may further respond to assertion of the memory fault interrupt 520 by causing the processing circuit 502 to reset. The reset and reinitialization of the memory component 508 can significantly increase system latency and decrease performance. Latency may refer to delays in processing or delays in responding to messages, interrupts, commands, device-generated real-time events, and/or events generated based on sensor-generated data or status. In some instances, latency may be measured as the time elapsed between receipt of a message, interrupt, or command and the response to the message, interrupt, or command. In some instances, latency may be measured as the time elapsed between receipt of a message, interrupt, or command and the processing or commencement of processing of the message, interrupt, or command. Other measures of latency may be employed.

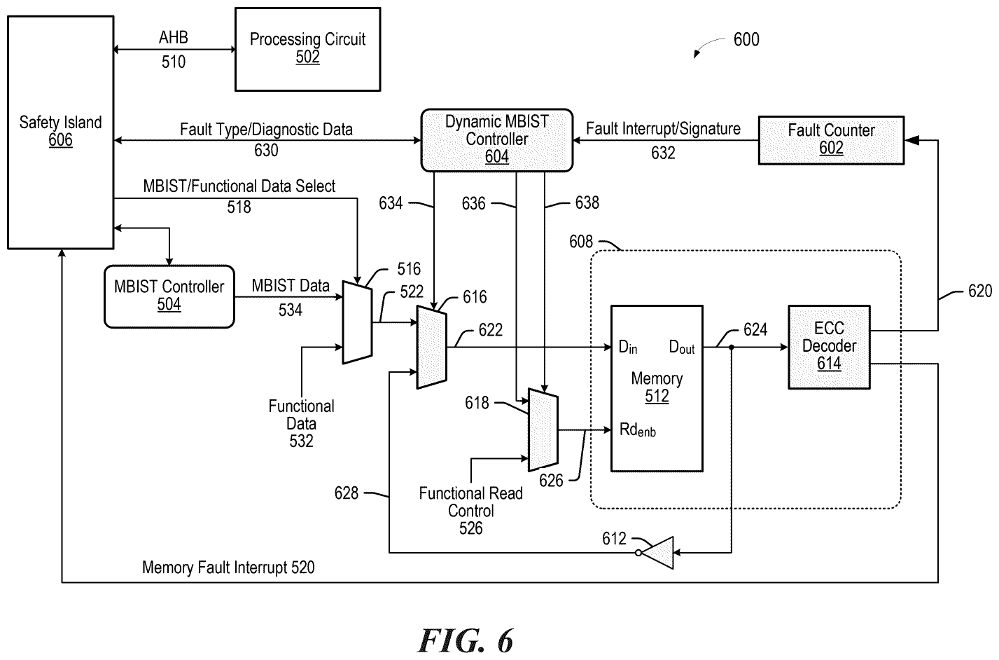

FIG. 6 is a block diagram illustrating a configuration of subsystems and circuits 600 that may perform self-testing and identification of transient fault conditions. Certain of the subsystems and circuits 600 correspond to certain of the subsystems and circuits 500 illustrated in FIG. 5. The self-testing may be directed to a memory component 608. In the illustrated example, the memory component 608 of FIG. 6 corresponds to the external memory 404 coupled to the processing circuit 402 of FIG. 4. In other examples, the memory component 608 of FIG. 6 corresponds to the internal memory 414 of the processing circuit 402 of FIG. 4. The memory component 608 includes one or more memory devices 512 that can provide an addressable memory space spanning an address range. The memory component 608 further includes an ECC decoder 614 configured according to certain aspects of this disclosure to identify data errors within the memory space provided by the one or more memory devices 512. The ECC decoder 614 may assert a memory fault interrupt 520 that causes one or more circuits or modules in a safety island 606 to initiate corrective action, and/or to notify an operator or notify other components or elements of an autonomous or driver operated vehicle of the potential consequences of the data corruption. The safety island 606 may be configured according to certain aspects of this disclosure to initiate a dynamic self-testing procedure that can distinguish between transient and permanent fault conditions. In some instances, the safety island 606 may couple to a processing circuit 502 through a bus 510 that is operated in accordance with AHB protocols.

The safety island 606 may be configured to manage or monitor the operation of a conventional BIST controller, such as the MBIST controller 504 illustrated in FIG. 5. The MBIST controller 504 may test certain aspects of the performance, accuracy, and reliability of the memory component 608 during system initialization. In one example, a circuit in the safety island 606 may provide a control signal to a multiplexer 516 that selects between a test data stream 534 and functional data 532 that is received during normal operation. During system initialization, the multiplexer 516 selects the test data stream 534 to be provided as data input 522 of the memory devices 512. The test data stream 534 may be written to multiple locations across the address range of the memory component 608. In one example, test data is written to every address in the address range. In another example, test data is written to random addresses throughout the address range. The MBIST controller 504 may then test the memory devices 512 to ensure the integrity of the stored data as described in relation to FIG. 5.

The data input 522 provided by the multiplexer 516 is forwarded to the memory devices 512 through an output 622 of a second multiplexer 616 during system initialization and normal operation. A select signal 634 provided by a dynamic MBIST controller 604 may configure the second multiplexer 616 to select a different data flow when dynamic self-testing is enabled in order to identify transient fault conditions. Dynamic self-testing may be enabled when the ECC decoder 614 asserts a memory fault interrupt 520 during normal operations. The dynamic MBIST controller 604 may be activated by a circuit in the safety island 606. In one example, the dynamic MBIST controller 604 may be implemented using a finite state machine. In another example, the dynamic MBIST controller 604 may be implemented using a processing circuit. The safety island 606 may provide the dynamic MBIST controller 604 with information 630 that can identify or can be used to identify a fault type. The information 630 provided to the dynamic MBIST controller 604 may include diagnostic data maintained within the safety island 606 and/or other fault and diagnostic information received from the ECC decoder 614 or from the processing circuit 502.

The ECC decoder 614 may provide a fault detect signal 620 that includes a pulse, transition, or edge that is generated for each fault detected. The fault detect signal 620 may be provided to a fault counter 602 that counts the number of faults detected while dynamic self-testing is enabled. In one example, the fault counter 602 may be reset when dynamic self-testing terminates. In another example, the fault counter 602 may reset when dynamic self-testing commences. In some implementations, the fault counter 602 receives a fault signature from the ECC decoder 614 as part of, or together with the fault detect signal 620. The fault signature may be provided when the memory fault interrupt 520 is asserted and may include a memory device identifier, an address of the memory location that is indicated as being associated with the data storage fault, and/or an ECC corresponding to the memory fault interrupt 520 being asserted. Fault related information may be forwarded to the dynamic MBIST controller 604. In the illustrated example, the fault counter 602 forwards one or more signals 632 to the dynamic MBIST controller 604. The signals 632 may include the fault signature and an indication of the number of faults detected.

The dynamic MBIST controller 604 may generate memory control signals (not shown) that are used to read data from the memory component 608 and to write data to the memory component 608. The dynamic MBIST controller 604 may generate a test version of a read enable signal 636. The dynamic MBIST controller 604 may provide a control signal 638 to a third multiplexer 618 that selects between the test version of the read enable signal 636 and the read enable signal 526 provided to the memory devices 512 during normal operation. The test version of the read enable signal 636 may be selected by the third multiplexer 618 to drive the read enable input 626 to the memory devices 512 during testing.

The dynamic MBIST controller 604 may cause address and control signals to be generated during dynamic self-testing. During each iteration of dynamic self-testing, the dynamic MBIST controller 604 may cause data 624 at an identified fault location to be read from the memory devices 512. The data 624 is inverted by an inverter 612 and inverted data 628 is fed back to the memory devices 512 through the second multiplexer 616. The dynamic MBIST controller 604 may cause the inverted data 628 to be written to the memory devices 512 at the identified fault location. During each iteration of dynamic self-testing, the ECC decoder 614 indicates whether a fault is detected in the data read from the identified fault location. Identification of a fault condition causes the fault counter 602 to increment. If no fault is detected, then circuits or modules in the safety island 606 may determine that the identified fault is a transient fault. In some implementations, the identification of a transient fault occurs after a single iteration of dynamic self-testing yields no fault indication. In some implementations, the identification of a transient fault occurs after multiple iterations of dynamic self-testing have yielded no fault indication.

For the purposes of this disclosure, a transient fault may be defined as a fault that endures for several microseconds before the corresponding memory location returns to a fully operable state. The fault counter 602 may be configured to extend a dynamic self-testing procedure for a sufficient period of time to permit the fault condition to clear and allow the affected memory location to return to a fully operable state. In certain implementations, a circuit or module of the safety island 606 may configure a programmable register with a threshold value that defines a maximum count value for the fault counter 602. The threshold value may correspond to a number of iterations of the dynamic self-testing procedure that ensures that a transient fault will be cleared. In certain implementations, a circuit or module of the safety island 606 may configure the fault counter 602 with an initial count value from which the fault counter 602 will count up or count down until an overflow or zero value occurs. In these implementations, the initial count value is configured to enable a number of iterations of the dynamic self-testing procedure that ensures that a transient fault will be cleared.

The dynamic MBIST controller 604 may monitor the output of the fault counter 602. The dynamic MBIST controller 604 may signal the safety island 606 that a permanent fault has been detected if the output of the fault counter 602 reaches or passes a threshold value. In one example, the threshold value may be preconfigured to be 100. In another example, the threshold value may be preconfigured to be 1,000. In other examples, the threshold value may be preconfigured to have a value that is less than 100. In still other examples, the threshold value may be preconfigured to have a value that is greater than 1,000. In some instances, the threshold value may be preconfigured to have a value falls within the range of 100 to 1,000.

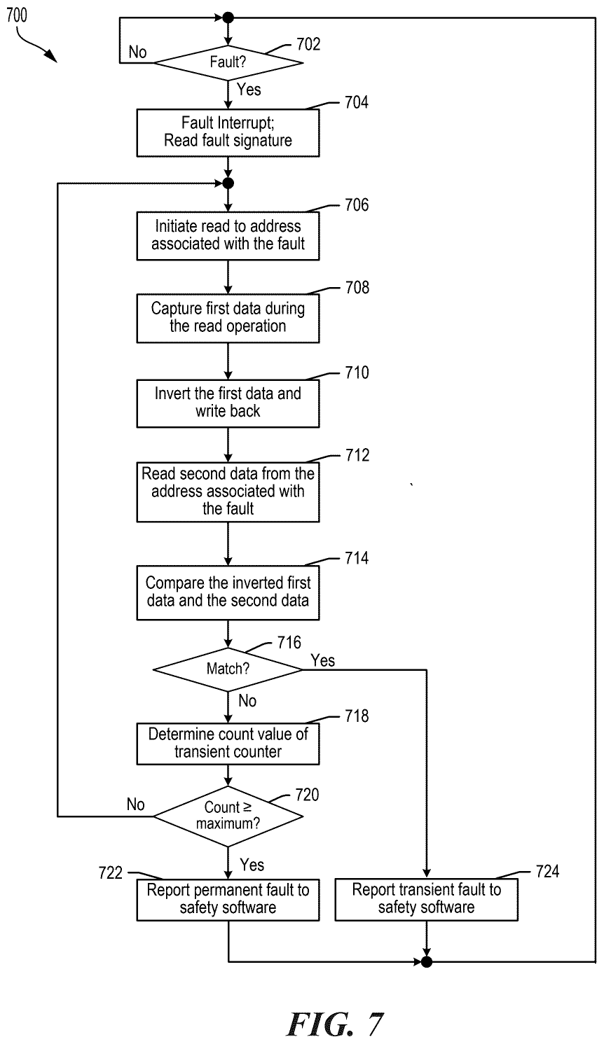

FIG. 7 is a flow chart that illustrates certain aspects of a dynamic self-testing procedure 700 that can be implemented using the subsystems and circuits 600 illustrated in FIG. 6. In some implementations, the dynamic self-testing procedure 700 may be implemented, managed, or controlled by the dynamic MBIST controller 604 of FIG. 6.

The dynamic MBIST controller 604 is initially in an idle or inactive state as illustrated by block 702. The dynamic MBIST controller 604 remains at block 702 until a read fault in the memory component 608 is indicated by the ECC decoder 614. The fault indication triggers the dynamic MBIST controller 604 and the dynamic self-testing procedure 700 begins at block 704. The dynamic MBIST controller 604 may halt incoming memory access requests. Memory access may be stalled until the fault is cleared as transient or other corrective action has been taken to restore the memory component 608 to an operable state. In one example, a subsystem reset may be performed in an attempt to clear and restore permanently faulty memory. In another example, the address or range of addresses of permanently faulty memory may be recorded and access to the associated memory may be blocked.

At block 704, the dynamic MBIST controller 604 may receive or retrieve a fault signature and/or other information provided with a fault interrupt by the ECC decoder 614 after a fault has been indicated. The fault signature may include a memory device identifier, an address of the faulty location, and an associated ECC. The ECC may be generated as a Hamming code, a Hsiao code, a Reed-Solomon error correction code, or the like. The ECC may enable single-bit error correction and double-bit error detection (SEC-DED).

At block 706, the dynamic MBIST controller 604 may initiate a read operation to retrieve first data stored at the address of the memory location identified as being faulty. At block 708, the dynamic MBIST controller 604 may capture the first data retrieved from the memory location identified as being faulty. At block 710, the dynamic MBIST controller 604 may cause an inverted version of the first retrieved data to be written back to the address of the memory location identified as being faulty.

At block 712, the dynamic MBIST controller 604 may read second data from the memory location identified as being faulty. In other words, the dynamic MBIST controller 604 may read from the memory location identified as being faulty again. At block 714, the dynamic MBIST controller 604 may compare the second data with expected data. The expected data may be the inverted version of the first retrieved data. At block 716, the dynamic MBIST controller 604 may determine whether the second data matches the inverted version of the first retrieved data. If the second data matches the inverted version of the first retrieved data, then the dynamic MBIST controller 604 may report to the safety island 606 at block 724 that the fault condition was a transient fault. If the second data does not match the inverted version of the first retrieved data, then the dynamic self-testing procedure 700 continues at block 718.

At block 718, the dynamic MBIST controller 604 may read the output of the fault counter 602 and compare the count value to a threshold value. In the illustrated example, the fault counter 602 is automatically incremented when the ECC decoder 614 asserts a memory fault interrupt 520. In some implementations, the dynamic MBIST controller 604 increments the fault counter 602 at block 718. At block 720, the dynamic MBIST controller 604 may determine whether the output of the fault counter 602 equals or exceeds a threshold value. The threshold value may correspond to a number of iterations of the dynamic self-testing procedure 700 that ensures that a transient fault will be cleared. The threshold value may be preconfigured based on a maximum latency specification or based on other application specifications. If the output of the fault counter 602 equals or exceeds the threshold value then, at block 722, the dynamic MBIST controller 604 may report to the safety island 606 that the fault condition is a permanent fault. If the output of the fault counter 602 is less than the threshold value, then a next iteration of the dynamic self-testing procedure 700 commences at block 706. After block 722 and block 724, the dynamic self-testing procedure 700 may restart at block 702.

Although addressing memory faults has been described, the present disclosure is not limited to memory faults, as faults in other components, such as a processor, may also be addressed.

As discussed, aspects of the present disclosure relate to fault categorization and handling in automotive subsystems. Because safety is a high priority in automotive design, identifying and categorizing system faults and taking corrective action is often specified for automotive subsystems. Various techniques are therefore directed to categorizing system faults and taking corrective action. For example, during compute processing, if a system reports a functional safety fault, the system then determines whether the fault is transient or permanent. If the fault is transient, the system may implement software to fix the fault. If the fault is permanent, however, the fault may not be fixed until a technician provides a hardware or software fix to the system. Permanent faults may therefore cause a large amount of time in which the automotive is not usable.

Aspects of the present disclosure are directed to a solution for fault categorization and handling. By implementing a slice-based architecture and transient fault detection in memory using dynamic built-in self-tests (BISTs), a system may identify a type of fault and shut off slices including a permanent fault. This solution allows the automotive subsystem to be used until a permanent fix is provided. Some aspects the present disclosure relating to transient fault detection in memory using BISTs have been discussed with respect to FIGS. 3-7.

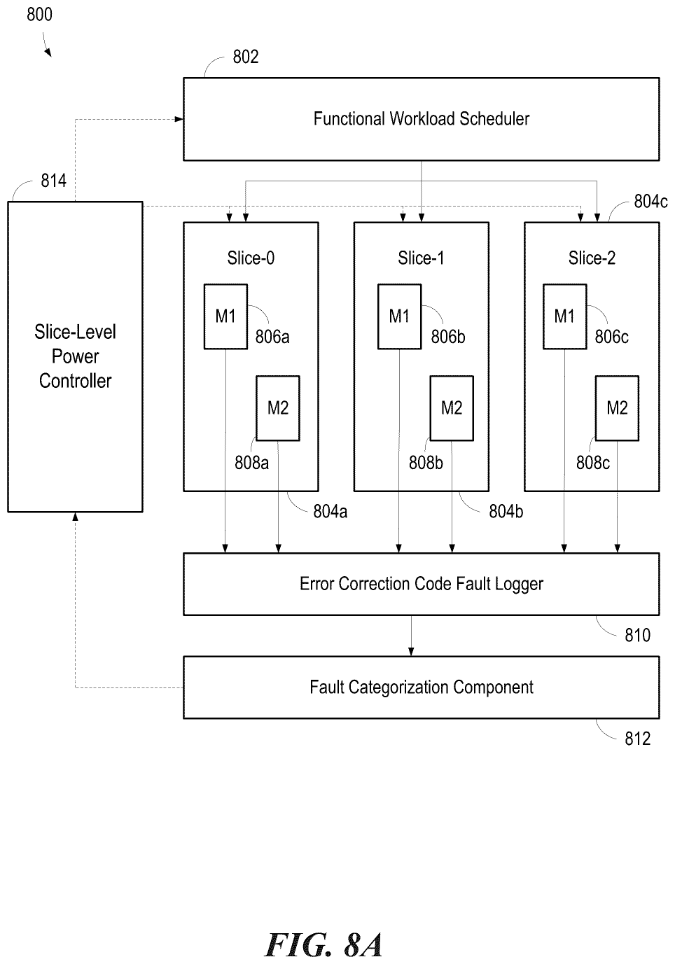

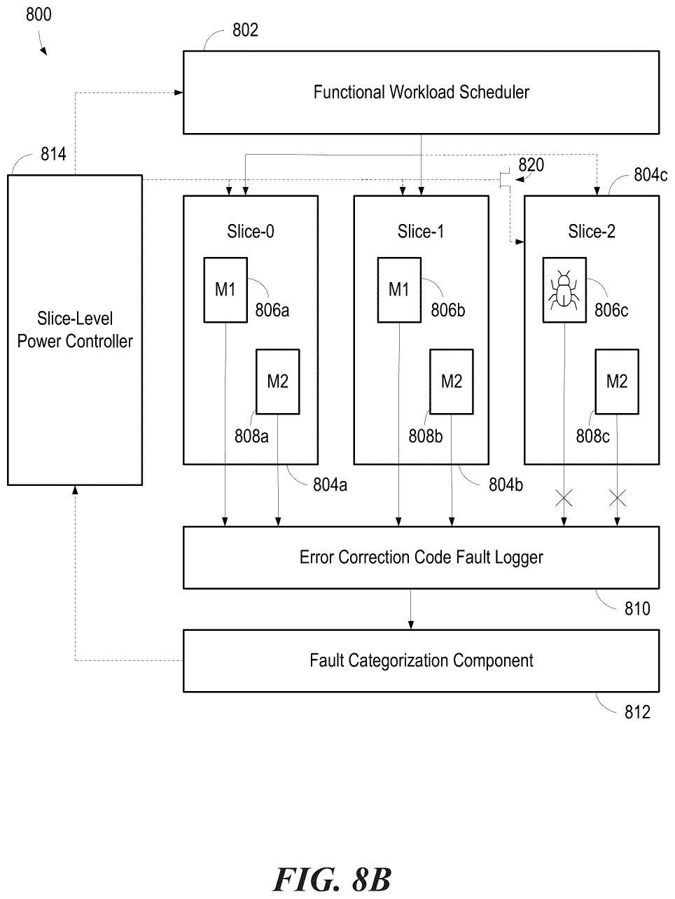

FIGS. 8A and 8B are block diagrams illustrating a scalable block-based processor 800 configured for fault management, in accordance with various aspects of the present disclosure. The processor 800 may be, for example, a GPU, similar to the GPU 104 of FIG. 1. As shown in FIG. 8A, a functional workload scheduler 802 is coupled to a first slice 804a, a second slice 804b, and a third slice 804c of the processor 800. The functional workload scheduler 802 manages the execution order and timing of workloads across available processing resources. For example, the functional workload scheduler may improve system efficiency by prioritizing and assigning workloads to the first slice 804a, second slice 804b, and third slice 804c. If a slice is power collapsed, the functional workload scheduler 802 adjusts the task distribution to ensure that active slices process the workload.

As shown in FIGS. 8A and 8B, a slice-based architecture differs significantly from conventional processor-based approaches. Conventional processor-based approaches often include a processor that performs a designated functionality on behalf of a system. For example, a GPU, such as the GPU 104, may be responsible for processing images. A CPU, such as the CPU 102 of FIG. 1, may be responsible for general-purpose processing. The CPU and the GPU perform different roles in a system, and are configured differently based on the specified role of each processor. Disabling a processor therefore often causes a reduction of system functionality. Processors may have dedicated functions, whereas a slice may not have a dedicated functionality. In some aspects, slices equally share a given workload and may each perform the same functionality. Conventional techniques exist to provide processing redundancy, but these techniques are associated with undesirable consequences. For example, some CPUs are configured to process images. Therefore, a CPU could serve as a backup processor for a GPU in case the GPU fails. However, GPUs are better at processing images than CPUs due to the architecture of GPUs being designed for parallelism. GPUs have thousands of smaller, less complex cores that can execute many tasks simultaneously, making them more efficient at handling large-scale computations such as image rendering. In contrast, a CPU has fewer, more complex cores for sequential processing and handling diverse tasks with greater flexibility but less parallel throughput. The GPU's ability to process many pixel operations concurrently allows for faster and more efficient image processing compared to the more general-purpose and sequentially focused CPU. Therefore, implementing a CPU as a backup processor for a GPU is not desirable.

Another conventional technique to provide processing redundancy includes the use of functional units in a dual core lockstep arrangement. Functional units are similar to processors in that functional units process workloads based on an assigned functionality. In a dual core lockstep arrangement, multiple copies of functional units exist on silicon. The redundant functional units do not scale together; one unit serves as a backup for another functional unit. Therefore, the redundant functional units take up valuable space on a processing chip without providing a corresponding increase in performance and also increase costs.

In contrast to conventional techniques, FIGS. 8A and 8B implement a slice-based architecture. Slices are replicated processing elements within a processor that allow for dynamic adjustment of processing. In other words, a slice (also referred to as a scalable block) is a set of sub modules in a processing core with a predefined function, which can be repeated multiple times in hardware to achieve higher performance without impacting the overall functionality of the core. A slice is a subset of a core and not a multi-core design. For example, the processor 800 may be a GPU that includes 36 arithmetic logic units (ALUs), where each slice (or scalable block) comprises 12 ALUs. Each slice can be power collapsed, meaning it can be turned off while routing workloads to a different slice. For instance, in image processing, the functional workload scheduler 802 may assign each slice a number of pixels to process. If each of the first slice 804a, second slice 804b, and third slice 804c is assigned 100 pixels per timeframe, the total throughput of the processor 800 is 300 pixels per timeframe. If one slice is power collapsed, the throughput decreases to 200 pixels per timeframe. Therefore, power collapsing slices may cause a reduction in performance, but no reduction in functionality of the processor 800. In video processing, power collapsing a slice may reduce system output resolution or alternatively reduce the number of frames processed per second. However, the processor 800 remains functional despite the disabled slice.

As discussed, each slice may comprise various computational and/or memory units. In the example illustrated with respect to FIGS. 8A and 8B, the first slice 804a includes a first memory 806a and a second memory 808a. The second slice 804b includes a third memory 806b and a fourth memory 808b. The third slice 804c includes a fifth memory 806c and a sixth memory 808c. Each memory component may be, for example, cache or registers implemented by the hosting slice to process workloads. The memory components are coupled to an ECC fault logger 810. The ECC fault logger 810 helps to increase data integrity by recording errors detected and corrected by ECC mechanisms (not illustrated) located in memory.

A fault categorization component 812 may perform fault categorization based on ECCs received from the ECC fault logger 810. For example, the fault categorization component 812 may perform functional safety fault categorization via the dynamic BIST algorithm described with respect to FIGS. 3-7. After receiving error information, such as ECCs, the fault categorization component 812 may determine whether a reported fault is a transient fault or a permanent fault. The fault categorization component 812 may then transmit the determination to a slice-level power controller 814.

The slice-level power controller 814 manages power routed to each of the first slice 804a, second slice 804b, and third slice 804c. The slice-level power controller 814 may power collapse a slice by powering the slice off or putting the slice in a low-power state. Power collapsing a slice may be based on an indication received from the fault categorization component 812. For example, if the slice-level power controller 814 receives an indication from the fault categorization component 812 that the third slice 804c has a permanent fault, the slice-level power controller 814 may power collapse the third slice 804c. The slice-level power controller 814 may then notify the functional workload scheduler 802 to reschedule workloads currently scheduled to the third slice 804c and/or to not schedule workloads to the third slice 804c.

In the example illustrated with respect to FIG. 8B, the fifth memory 806c in the third slice 804c experiences a fault and reports the fault to the ECC fault logger 810. The ECC fault logger 810 logs the fault and transmits fault information to the fault categorization component 812. The fault categorization component 812 then may categorize the fault as either a permanent fault or a transient fault. If, as in the example illustrated in FIG. 8B, the fault is a permanent fault, the fault categorization component 812 indicates the permanent fault to the slice-level power controller 814. The slice-level power controller 814 then power collapses the third slice 804c via a power gate 820. The slice-level power controller 814 also notifies the functional workload scheduler 802 of the third slice 804c being power collapsed by, for example, notifying the functional workload scheduler 802 not to schedule workloads on the third slice 804c. As a result, the remaining slices 804a, 804b continue the processing that was assigned to the third slice 804c, but at a reduced throughput. For example, a dashboard may be displayed at a lower resolution with the remaining slices 804a, 804b. As shown in FIG. 8B, the power gate 820 couples the slice-level power controller 814 to the third slice 804c. Other power gates (not illustrated) may couple the slice-level power controller 814 to the first slice 804a and second slice 804b.

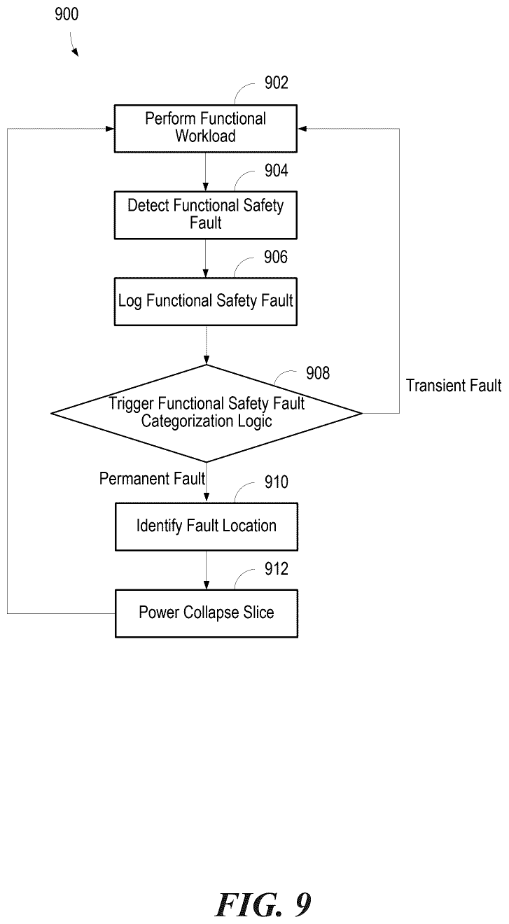

FIG. 9 is a flow chart illustrating a process 900 to address hardware faults in a slice-based processor, in accordance with various aspects of the present disclosure. The process 900 may be performed by a slice-based processor, such as the processor 800 of FIG. 8. At block 902, the process 900 includes performing a functional workload. For example, the process 900 may be implemented by a slice-based GPU, where the GPU is performing a graphical or computational task such as rendering an image. A functional workload scheduler, such as the functional workload scheduler 802, may assign each slice various workloads for the purpose of rendering the image.

At block 904, the process 900 includes detecting a functional safety fault. As discussed, functional safety faults may have a variety of causes, including solar flares and damage to the processor. Once a component within the processor, such as an ECC encoder, detects a functional safety fault, the component may transmit an error correction code to an ECC fault logger, such as the ECC fault logger 810 of FIG. 8. For instance, an ECC encoder may detect a functional safety fault by generating redundant bits and comparing them with bits received from a memory component. If a discrepancy exists between the generated bits and received redundant bits, the encoder may identify and transmit an ECC to the ECC fault logger 810. At block 906, the process 900 includes logging the functional safety fault. For example, the ECC fault logger 810 may store the ECC in a memory.

At block 908, the process 900 includes triggering functional safety fault categorization logic. In one implementation, the fault categorization logic is activated at block 908 when a memory location becomes faulty. An ECC decoder generates a fault interrupt along with a signature that includes the memory identifier, the faulty address location, and whether the fault is associated with single error correction or double error detection (SEC/DED). The fault interrupt then triggers a dynamic BIST controller, such as the dynamic MBIST controller 604 of FIG. 6. The dynamic BIST controller halts the incoming memory access, as the memory is determined to be faulty, and performs a fault categorization technique.

The fault categorization technique may include triggering a read-back on the faulty address and storing the read-data from the address. The read-data is inverted and written back to the same location. The dynamic BIST controller then compares this resulting data with expected data. If the dynamic BIST controller identifies a match between the resulting and the expected data, the fault is determined to be a transient fault. If the resulting data does not match the expected data, the dynamic BIST controller increments a counter and repeats the process until the data matches or the counter expires. If the data matches, the fault is identified as a transient fault. If the counter expires and the resulting data still does not match expected data, the dynamic BIST controller identifies the fault as a permanent fault. The fault categorization technique is further explained with respect to FIGS. 3-7.

If the fault is identified as a transient fault, the process 900 performs the functional workload again at block 902. The functional workload may be performed on the slice that hosted the transient fault. If the fault is identified as a permanent fault, the process 900 then identifies a fault location at block 910. For example, the processor 800 may identify a slice in which an error originated via information from an ECC. At block 912, the process 900 includes power collapsing the identified slice. For example, if a permanent fault is identified in the second slice 804b, the slice-level power controller 814 may divert power away from the second slice 804b. The slice-level power controller 814 may also transmit an indication to the functional workload scheduler 802 to prevent the functional workload scheduler 802 from scheduling workloads on the second slice 804b. After block 912, the process 900 may perform the functional workload again at block 902. For example, the processor 800 may then re-execute the functional workload on slices that do not host a permanent fault.

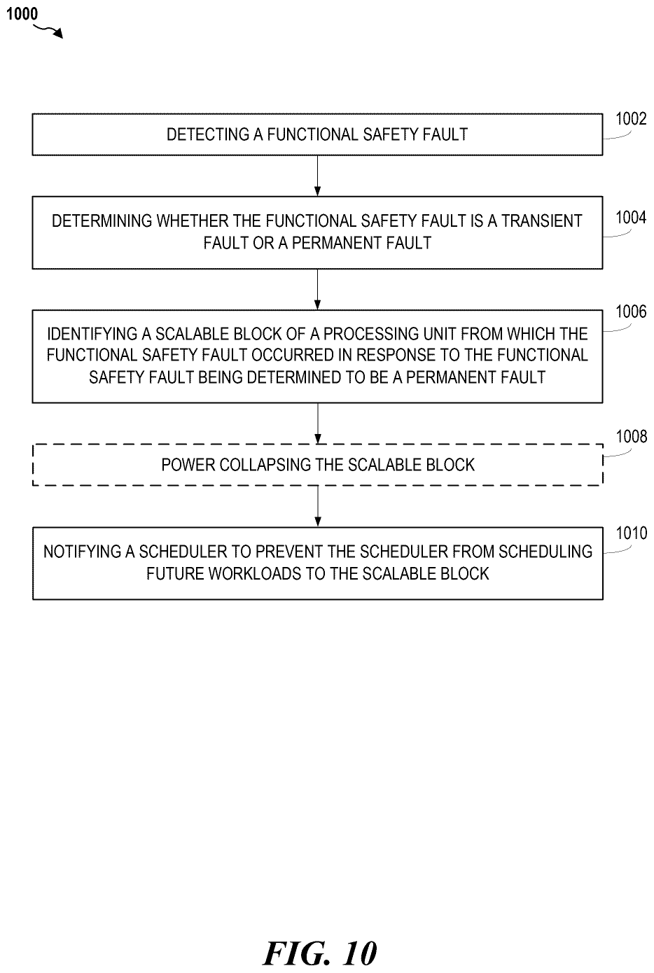

FIG. 10 is a flow chart illustrating an example process performed, for example, by a scalable block-based processor, in accordance with various aspects of the present disclosure. In some aspects, the process 1000 may include detecting a functional safety fault (block 1002). The process 1000 may detect the functional safety fault via an ECC fault logger. For example, an ECC encoder hosted by a scalable block may detect a hardware fault, such as a faulty memory component. The scalable block may then report the fault to the ECC fault logger. The ECC fault logger may then log the fault in memory and transmit fault information to a fault categorization component.

In some aspects, the process 1000 may also include determining whether the functional safety fault is a transient fault or a permanent fault (block 1004). For instance, the process 1000 may capture a first set of read data from a faulty address. The process 1000 may then invert the first set of read data and write the first set of read data to the faulty address. Then, the process 1000 may capture a second set of read data from the faulty address. The process 1000 may then compare the first set of read data and the second set of read data and determine that the functional safety fault is a transient fault based on the first set of read data matching the second set of read data.

As discussed, slices or scalable blocks are a set of sub modules in a processing core with a predefined function, which can be repeated multiple times in hardware to achieve higher performance without impacting the overall functionality of the core. In some aspects, the process 1000 may further include identifying a scalable block of a processing unit from which the functional safety fault occurred in response to the functional safety fault being determined to be a permanent fault (block 1006). For instance, a scalable block-based GPU may identify a scalable block of the GPU from which a functional safety fault occurred by interpreting fault information provided by a fault logger, such as the ECC fault logger 810 as shown in FIGS. 8A and 8B.

In some aspects, the process 1000 may optionally include power collapsing the scalable block (block 1008). In some implementations, a scalable block-level power controller may power collapse a scalable block after receiving a permanent fault indication from a fault categorization component, the permanent fault indication identifying the slice as faulty. The scalable block-level power controller may then power collapse the scalable block by toggling a power gate coupled to the scalable block. It is also conceived that the permanent fault indication may identify more than one scalable block. If the permanent fault indication identifies more than one scalable block, then the scalable block-level power controller may power collapse each identified scalable block.

In some aspects, the process 1000 may also include notifying a scheduler to prevent the scheduler from scheduling future workloads to the scalable block (block 1010). For instance, after receiving a permanent fault indication, the scalable block-level power controller may transmit the same permanent fault indication or a new permanent fault indication to a functional workload scheduler. The functional workload scheduler may then stop scheduling workloads on the scalable block or scalable blocks identified by the permanent fault indication. The functional workload scheduler may then re-execute a workload on scalable blocks other than the scalable block or scalable blocks identified by the permanent fault indication.

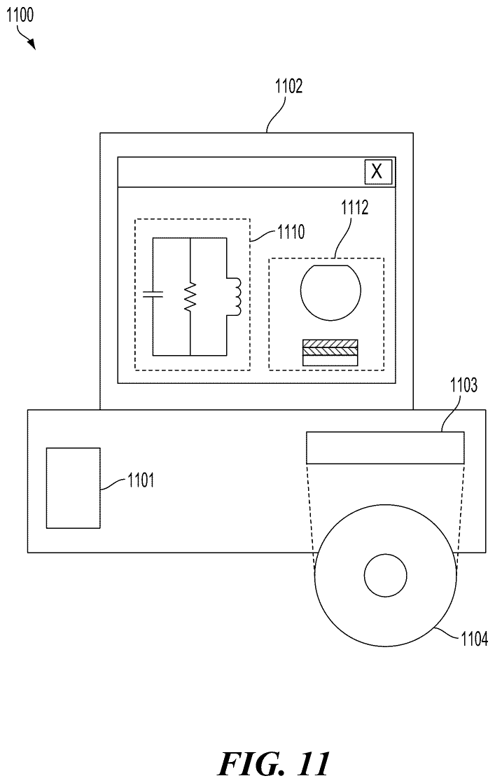

FIG. 11 is a block diagram illustrating a design workstation 1100 used for circuit, layout, and logic design of a semiconductor component, such as the slice-based processor, disclosed above. The design workstation 1100 includes a hard disk 1101 containing operating system software, support files, and design software such as Cadence or OrCAD. The design workstation 1100 also includes a display 1102 to facilitate design of a circuit 1110 or a semiconductor component 1112, such as the disclosed slice-based processor. A storage medium 1104 is provided for tangibly storing the design of the circuit 1110 or the semiconductor component 1112 (e.g., the disclosed slice-based processor or a slice-level power controller). The design of the circuit 1110 or the semiconductor component 1112 may be stored on the storage medium 1104 in a file format such as GDSII or GERBER. The storage medium 1104 may be a CD-ROM, DVD, hard disk, flash memory, or other appropriate device. Furthermore, the design workstation 1100 includes a drive apparatus 1103 for accepting input from or writing output to the storage medium 1104.

Data recorded on the storage medium 1104 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1104 facilitates the design of the circuit 1110 or the semiconductor component 1112 by decreasing the number of processes for designing semiconductor wafers.

### EXAMPLE ASPECTS

Aspect 1: A method, comprising: detecting a functional safety fault; determining whether the functional safety fault is a transient fault or a permanent fault; identifying a slice of a processing unit from which the functional safety fault occurred in response to the functional safety fault being determined to be the permanent fault; and notifying a scheduler to prevent the scheduler from scheduling future workloads to the scalable block.

Aspect 2: The method of Aspect 1, further comprising re-executing a workload on the scalable block in response to the functional safety fault being determined as the transient fault, the re-executing occurring after a predetermined time has elapsed.

Aspect 3: The method of Aspect 1 or 2, in which determining whether the functional safety fault is the transient fault or the permanent fault comprises: storing a first set of read data from a faulty address; inverting the first set of read data; writing the inverted first set of read data to the faulty address; storing a second set of read data from the faulty address; comparing the first set of read data and the second set of read data; and determining the functional safety fault is the transient fault based on the first set of read data matching the second set of read data.

Aspect 4: The method of any of the Aspects 1-3, further comprising: resetting a counter; comparing sets of data read from the faulty address and written to the faulty address and incrementing the counter after each comparison until the functional safety fault is determined to be the transient fault or the counter is greater than a threshold; and determining the functional safety fault is the permanent fault based on the counter being greater than the threshold.

Aspect 5: The method of any of the Aspects 1-4, further comprising power collapsing the scalable block.

Aspect 6: The method of any of the Aspects 1-5, in which power collapsing the scalable block comprises toggling a power gate via a scalable block-level power controller.

Aspect 7: The method of any of the Aspects 1-6, further comprising re-executing a workload scheduled to the scalable block on other scalable blocks in response to the functional safety fault being determined as the permanent fault.

Aspect 8: An apparatus, comprising: a processing unit comprising a plurality of scalable blocks; a functional workload scheduler coupled to an input of each of the plurality of scalable blocks to schedule workloads; a functional safety fault categorization module coupled to an output of each of the plurality of scalable blocks to categorize functional safety faults as either permanent faults or transient faults; and a scalable block-level power controller coupled to the functional safety fault categorization module to receive a categorization of a safety fault from one of the plurality of scalable blocks, and coupled to the functional workload scheduler to instruct preventing of workload scheduling for a scalable block from which a permanent fault is detected.

Aspect 9: The apparatus of Aspect 8, in which the apparatus is a graphics processing unit or a central processing unit.

Aspect 10: The apparatus of Aspect 8 or 9, further comprising a plurality of power gates, each power gate of the plurality of power gates coupling a respective scalable block of the plurality of scalable blocks to the scalable block-level power controller.

Aspect 11: The apparatus of any of the Aspects 8-10, in which the scalable block-level power controller is coupled to each of the plurality of scalable blocks to collapse power to the scalable block from which the permanent fault is detected.

Aspect 12: The apparatus of any of the Aspects 8-11, in which the functional workload scheduler is further configured to re-execute a workload on the scalable block from which the permanent fault is detected in response to a transient fault indication, the re-executing occurring after a predetermined time has elapsed.

Aspect 13: The apparatus of any of the Aspects 8-12, in which the functional workload scheduler is further configured to re-execute a workload scheduled to the scalable block on one or more scalable blocks other than the scalable block from which the permanent fault is detected in response to a permanent fault indication.

Aspect 14: An apparatus, comprising: means for detecting a functional safety fault; means for determining whether the functional safety fault is a transient fault or a permanent fault; means for identifying a scalable block of a processing unit from which the functional safety fault occurred in response to the functional safety fault being determined to be the permanent fault; and means for notifying a scheduler to prevent the scheduler from scheduling future workloads to the scalable block.

Aspect 15: The apparatus of Aspect 14, further comprising means for re-executing a workload on the scalable block in response to the functional safety fault being determined as the transient fault, the re-executing occurring after a predetermined time has elapsed.

Aspect 16: The apparatus of Aspect 14 or 15, in which means for determining whether the functional safety fault is the transient fault or the permanent fault comprises: means for storing a first set of read data from a faulty address; means for inverting the first set of read data; means for writing the inverted first set of read data to the faulty address; means for storing a second set of read data from the faulty address; means for comparing the first set of read data and the second set of read data; and means for determining the functional safety fault is the transient fault based on the first set of read data matching the second set of read data.

Aspect 17: The apparatus of any of the Aspects 14-16, further comprising: means for resetting a counter; means for comparing sets of data read from the faulty address and written to the faulty address and incrementing the counter after each comparison until the functional safety fault is determined to be the transient fault or the counter is greater than a threshold; and means for determining the functional safety fault is the permanent fault based on the counter being greater than the threshold.

Aspect 18: The apparatus of any of the Aspects 14-17, further comprising means for power collapsing the scalable block.

Aspect 19: The apparatus of any of the Aspects 14-18, in which power collapsing the scalable block comprises toggling a power gate via a scalable block-level power controller.

Aspect 20: The apparatus of any of the Aspects 14-19, further comprising means for re-executing a workload scheduled to the scalable block on other scalable blocks in response to the functional safety fault being determined as the permanent fault.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method, comprising:
detecting a functional safety fault;
determining whether the functional safety fault is a transient fault or a permanent fault;
identifying a scalable block of a processing unit from which the functional safety fault occurred in response to the functional safety fault being determined to be the permanent fault; and
notifying a scheduler to prevent the scheduler from scheduling future workloads to the scalable block.

2. The method of claim 1, further comprising re-executing a workload on the scalable block in response to the functional safety fault being determined as the transient fault, the re-executing occurring after a predetermined time has elapsed.

3. The method of claim 1, in which determining whether the functional safety fault is the transient fault or the permanent fault comprises:
storing a first set of read data from a faulty address;
inverting the first set of read data;
writing the inverted first set of read data to the faulty address;
storing a second set of read data from the faulty address;
comparing the first set of read data and the second set of read data; and
determining the functional safety fault is the transient fault based on the first set of read data matching the second set of read data.

4. The method of claim 3, further comprising:
resetting a counter;
comparing sets of data read from the faulty address and written to the faulty address and incrementing the counter after each comparison until the functional safety fault is determined to be the transient fault or the counter is greater than a threshold; and
determining the functional safety fault is the permanent fault based on the counter being greater than the threshold.

5. The method of claim 1, further comprising power collapsing the scalable block.

6. The method of claim 5, in which power collapsing the scalable block comprises toggling a power gate via a scalable block-level power controller.

7. The method of claim 1, further comprising re-executing a workload scheduled to the scalable block on other scalable blocks in response to the functional safety fault being determined as the permanent fault.

8. An apparatus, comprising:
a processing unit comprising a plurality of scalable blocks;
a functional workload scheduler coupled to an input of each of the plurality of scalable blocks to schedule workloads;
a functional safety fault categorization module coupled to an output of each of the plurality of scalable blocks to categorize functional safety faults as either permanent faults or transient faults; and
a scalable block-level power controller coupled to the functional safety fault categorization module to receive a categorization of a safety fault from one of the plurality of scalable blocks, and coupled to the functional workload scheduler to instruct preventing of workload scheduling for a scalable block from which a permanent fault is detected.

9. The apparatus of claim 8, in which the apparatus is a graphics processing unit or a central processing unit.

10. The apparatus of claim 8, further comprising a plurality of power gates, each power gate of the plurality of power gates coupling a respective scalable block of the plurality of scalable blocks to the scalable block-level power controller.

11. The apparatus of claim 8, in which the scalable block-level power controller is coupled to each of the plurality of scalable blocks to collapse power to the scalable block from which the permanent fault is detected.

12. The apparatus of claim 8, in which the functional workload scheduler is further configured to re-execute a workload on the scalable block from which the permanent fault is detected in response to a transient fault indication, the re-executing occurring after a predetermined time has elapsed.

13. The apparatus of claim 8, in which the functional workload scheduler is further configured to re-execute a workload scheduled to the scalable block on one or more scalable blocks other than the scalable block from which the permanent fault is detected in response to a permanent fault indication.

14. An apparatus, comprising:
means for detecting a functional safety fault;
means for determining whether the functional safety fault is a transient fault or a permanent fault;
means for identifying a scalable block of a processing unit from which the functional safety fault occurred in response to the functional safety fault being determined to be the permanent fault; and
means for notifying a scheduler to prevent the scheduler from scheduling future workloads to the scalable block.

15. The apparatus of claim 14, further comprising means for re-executing a workload on the scalable block in response to the functional safety fault being determined as the transient fault, the re-executing occurring after a predetermined time has elapsed.

16. The apparatus of claim 14, in which means for determining whether the functional safety fault is the transient fault or the permanent fault further comprises:
means for storing a first set of read data from a faulty address;
means for inverting the first set of read data;
means for writing the inverted first set of read data to the faulty address;
means for storing a second set of read data from the faulty address;
means for comparing the first set of read data and the second set of read data; and
means for determining the functional safety fault is the transient fault based on the first set of read data matching the second set of read data.

17. The apparatus of claim 16, further comprising:
means for resetting a counter;
means for comparing sets of data read from the faulty address and written to the faulty address and incrementing the counter after each comparison until the functional safety fault is determined to be the transient fault or the counter is greater than a threshold; and
means for determining the functional safety fault is the permanent fault based on the counter being greater than the threshold.

18. The apparatus of claim 14, further comprising means for power collapsing the scalable block.

19. The apparatus of claim 18, in which the means for power collapsing the scalable block further comprises means for toggling a power gate via a scalable block-level power controller.

20. The apparatus of claim 14, further comprising means for re-executing a workload scheduled to the scalable block on other scalable blocks in response to the functional safety fault being determined as the permanent fault.
